(19) United States
(12) Patent Application Publication
(10) Pub. No.: US 2015/0348145 A1
(43) Pub. Date: Dec. 3, 2015

(54) Support System That Can Customize Attribute Kind of Product for Each Dealer, Recording Medium, and Support Method

(71) Applicant: Kyocera Document Solutions Inc., Osaka (JP)

(72) Inventor: Koki Nakajima, Osaka (JP)

(21) Appl. No.: 14/726,460

(22) Filed: May 30, 2015

(30) Foreign Application Priority Data
May 30, 2014 (JP) 2014-112555

(51) Int. Cl. G06Q 30/06

(52) U.S. Cl. CPC G06Q 30/0601

(57) ABSTRACT

A support system includes a function execution circuit and a customer information management circuit. The function execution circuit uses customer information indicative of a specific content related to a customer to execute a specific function. The customer information management circuit manages the customer information. The customer information management circuit manages a piece of attribute kind information storing a kind of attribute for a product for each dealer, and attribute value information storing an attribute value indicative of an actual content for the kind for each of combinations of the dealers, the products, and the kinds, as a part of the customer information. The function execution circuit uses the attribute acquired based on the attribute kind information and the attribute value information to execute the function.

### INCORPORATION BY REFERENCE

This application is based upon, and claims the benefit of priority from, corresponding Japanese Patent Application No. 2014-112555 filed in the Japan Patent Office on May 30, 2014, the entire contents of which are incorporated herein by reference.

### BACKGROUND

Unless otherwise indicated herein, the description in this section is not prior art to the claims in this application and is not admitted to be prior art by inclusion in this section.

There is known a support system that uses customer information indicative of specific contents related to a customer to execute specific functions as the support system that supports sales activities of a dealer who sells products to the customer.

### SUMMARY

A support system according to an aspect of the disclosure includes a function execution circuit and a customer information management circuit. The function execution circuit uses customer information indicative of a specific content related to a customer to execute a specific function. The customer information management circuit manages the customer information. The customer information management circuit manages a piece of attribute kind information storing a kind of attribute for a product for each dealer, and attribute value information storing an attribute value indicative of an actual content for the kind for each of combinations of the dealers, the products, and the kinds, as a part of the customer information. The function execution circuit uses the attribute acquired based on the attribute kind information and the attribute value information to execute the function.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a system according to an embodiment of the disclosure.

FIG. 2 illustrates a relationship between dealers and an administrator of a support server according to the embodiment.

FIG. 3 illustrates the support server according to the embodiment.

FIG. 4 illustrates a database server according to the embodiment.

FIG. 5 illustrates an exemplary management node table according to the embodiment.

FIG. 6 illustrates an exemplary management device table according to the embodiment.

FIG. 7 illustrates an exemplary management device master table according to the embodiment.

FIG. 8 illustrates an exemplary management device information table according to the embodiment.

FIG. 9 illustrates operations executed by a support server according to the embodiment when use of functions is requested.

FIG. 10 illustrates operations executed by the support server according to the embodiment when a kind of attribute is customized.

FIG. 11 illustrates an exemplary management device master table customized by the operations of the support server illustrated in FIG. 10.

FIG. 12 illustrates operations executed by the support server according to the embodiment when an input of attribute value is requested.

FIG. 13 illustrates an exemplary management device information table with the attribute values inputted by the operations of the support server illustrated in FIG. 12.

FIG. 14 illustrates a system according to an embodiment of the disclosure where the system includes multiple database servers.

FIG. 15 illustrates an exemplary management node table stored in the database servers according to the embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

Hereinafter, an embodiment of the disclosure will be described with reference to the attached drawings.

The following describes the configuration of a system 10 according to the embodiment.

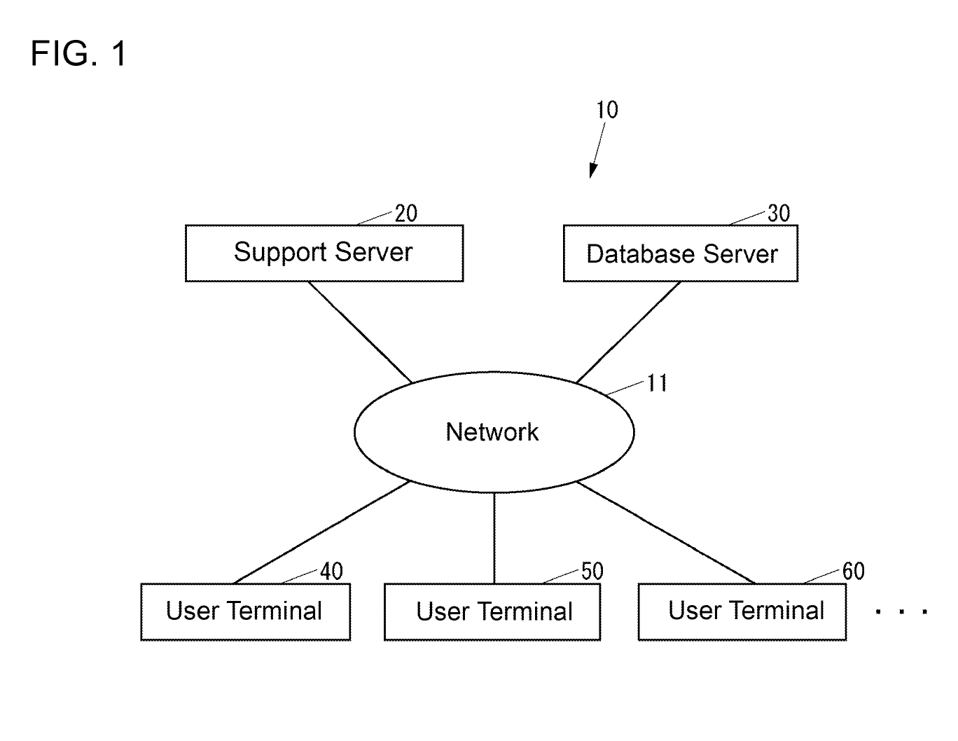

FIG. 1 illustrates the system 10 according to the embodiment.

As illustrated in FIG. 1, the system 10 includes: a support server 20 functioned as a support system that supports sales activities of a plurality of dealers who sell products to customers; a database server 30 that stores customer information indicative of specific contents related to a customer; and a user terminal 40, a user terminal 50, and a user terminal 60 that are used by the dealers.

The support server 20 is communicatively connected to the database server 30, the user terminal 40, the user terminal 50, and the user terminal 60 one another via a network 11, such as an Internet.

The system 10 may include many user terminals similar to the user terminal 40 in addition to the user terminal 40, the user terminal 50, and the user terminal 60.

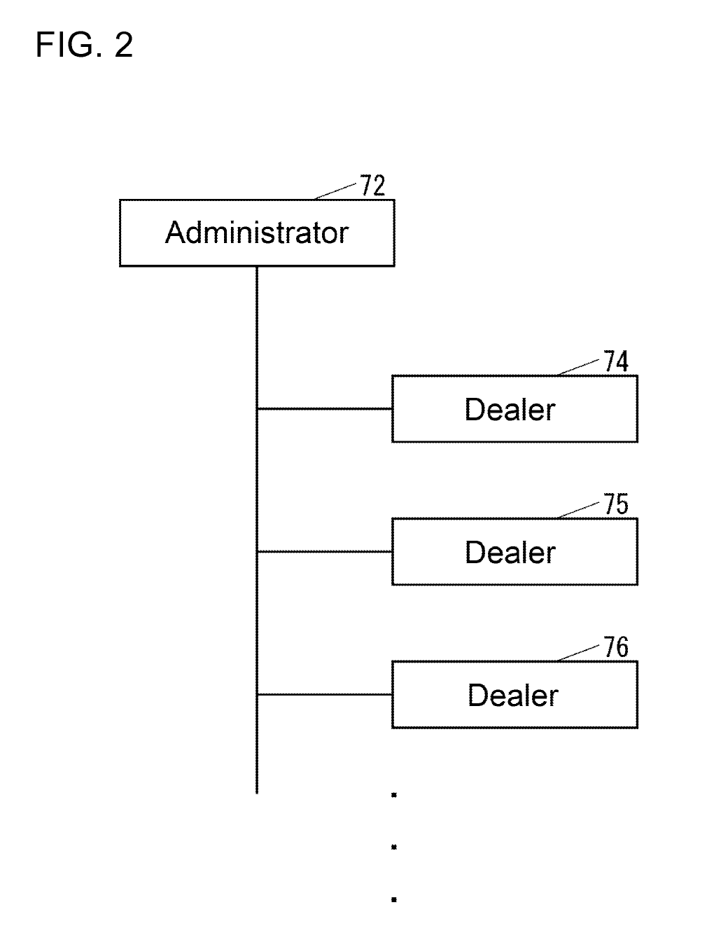

FIG. 2 illustrates a relationship between the dealers and an administrator 72 of the support server 20 (see FIG. 1).

As illustrated in FIG. 2, users of the system 10 (see FIG. 1) include the administrator 72 of the support server 20, a dealer 74, a dealer 75, and a dealer 76 that sell the products to the customers.

The users of the support server 20 may include many dealers in addition to the dealer 74, the dealer 75, and the dealer 76.

The administrator 72 has an authority to manage the dealers in the support server 20 (see FIG. 1) and executes a maintenance and operation of the support server 20. The administrator 72 is, for example, a sales company of the product that the dealer sells to the customer. For example, a support service provided by the support server 20 is the service provided to the dealer for which the manufacturer's subsidiary sales company supports the sales management and operation of the products executed by the dealer with the aim of the promotion of utilization of own products. The manufacturer's subsidiary sales company has the organizations of a Regional Headquarter (RHQ) for overseeing the operations across countries and a Second Level (SC) for executing the operations restricted to organizational levels equal to or less than the country-level in a hierarchical structure.

The product may include such as an electronic device. The electronic equipment may include such as business equipment. The business equipment may include, for example, an image forming apparatus such as a Multifunction Peripheral (MFP), a printer-only machine, or other equipment. For example, the support server 20 may provide the support service that supports the sales management and operation of the image forming apparatus such as a Managed Print Service (MPS) executed by the dealer.

The dealer is the one who is managed by the administrator 72 in the support server 20. However, the dealer is an independent and different company from the administrator 72, and able to optionally handle any products such as the competing products with the administrator 72 as well as the products of the administrator 72.

The support server 20 and the database server 30 illustrated in FIG. 1 are built in an on-premises environment or on a cloud system owned by the administrator 72 (see FIG. 2).

The database server 30 stores the customer information by each dealer. The customer information includes the information of a plurality of items. For example, the customer information includes an item of a customer name. The customer information item includes various attributes for the product in the customer's possession, such as a model name, a setting, a status, usage history, or other items.

The user terminals included in the system 10 are used by the respective different dealers. For example, the users for the user terminals 40, 50, and 60 are the dealers 74, 75, 76 (see FIG. 2), respectively.

The user terminals 40, 50, and 60 exist in the on-premises environments owned by the dealers 74, 75, and 76, respectively. The user terminal 40, the user terminal 50, and the user terminal 60 are each constituted of, for example, a computer such as a Personal Computer (PC), a tablet terminal, or other equipment.

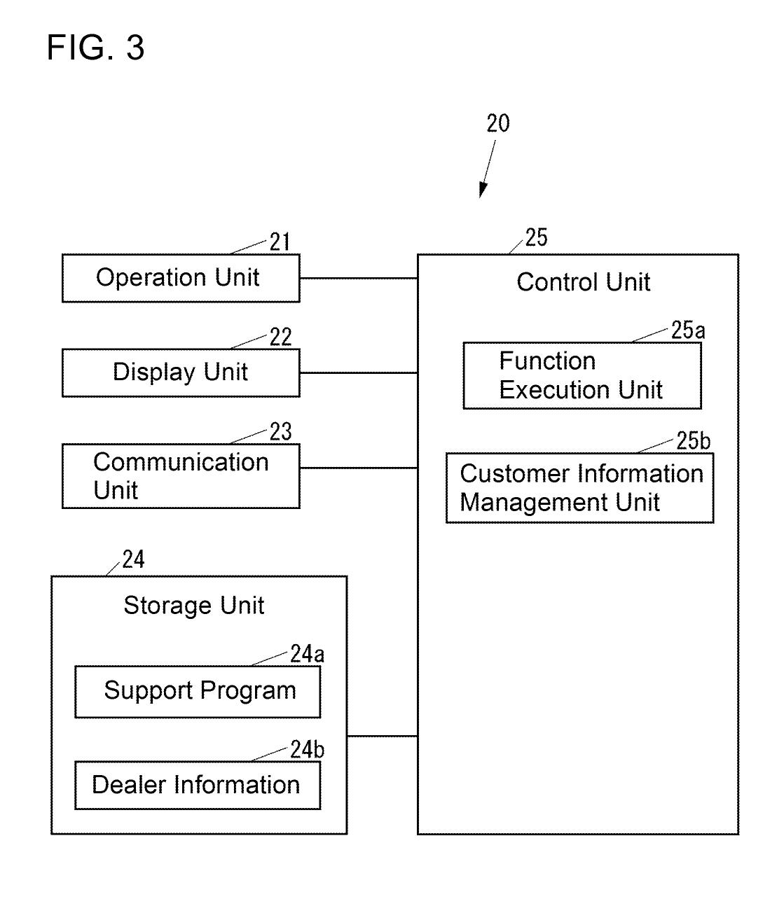

FIG. 3 illustrates the support server 20.

As illustrated in FIG. 3, the support server 20 is a circuit that includes an operation unit 21, a display unit 22, a communication unit 23, a storage unit 24, and a control unit 25. The operation unit 21 is an input circuit such as a computer mouse and a keyboard for receiving various kinds of operations. The display unit 22 is a display circuit such as a Liquid Crystal Display (LCD) that displays various kinds of information. The communication unit 23 is a network communication circuit that communicates with an external device via the network 11 (see FIG. 1). The storage unit 24 is a storage circuit such as a Hard Disk Drive (HDD) that stores programs and various kinds of data. The control unit 25 is a circuit that controls the entire support server 20. The support server 20 is constituted of, for example, a computer such as a PC.

The storage unit 24 is a non-transitory computer-readable recording medium, and stores a support program 24a that supports the sales activities of the dealer who is the user of the user terminal. The support program 24a may be installed to the support server 20 at production stage of the support server 20, may be additionally installed from a storage medium such as a Compact Disk (CD), a Digital Versatile Disk (DVD) to the support server 20, or may be additionally installed from the network 11 to the support server 20.

The storage unit 24 may store dealer information 24b indicative of the various contents related to the dealer. For example, the dealer information 24b includes a dealer's login ID and password, and a dealer name.

The control unit 25 includes, for example, a Central Processing Unit (CPU), a Read Only Memory (ROM), which stores the program and various kinds of data, and a Random Access Memory (RAM), which is used as a work area of the CPU. The CPU may execute the program that is stored in the ROM or the storage unit 24.

The control unit 25 executes the support program 24a stored in the storage unit 24. This ensures that the control unit 25 functions as a function execution unit 25a, which executes the specific functions using the customer information, and a customer information management unit 25b, which manages the customer information.

The function executed by the function execution unit 25a may be the one that supports for the dealer to sell the products. For example, the function that creates a sales proposal for a new product capable of improving the customer's present circumstances based on the usage history of the product in the customer's possession among the customer information of the dealer is considered.

The function executed by the function execution unit 25a may be the one that supports for the dealer to operate the products. For example, one function is considered to automatically order consumables for the product based on the consumption of the consumables for the product in the customer's possession among the customer information of the dealer. Another function is considered to remotely modify the settings for the product based on the condition of the product in the customer's possession among the customer information of the dealer. Yet another function is also considered to determine whether or not product failure occurs and notifies the appropriate actions to be taken in the event of a product fault based on the condition of the product in the customer's possession among the customer information of the dealer.

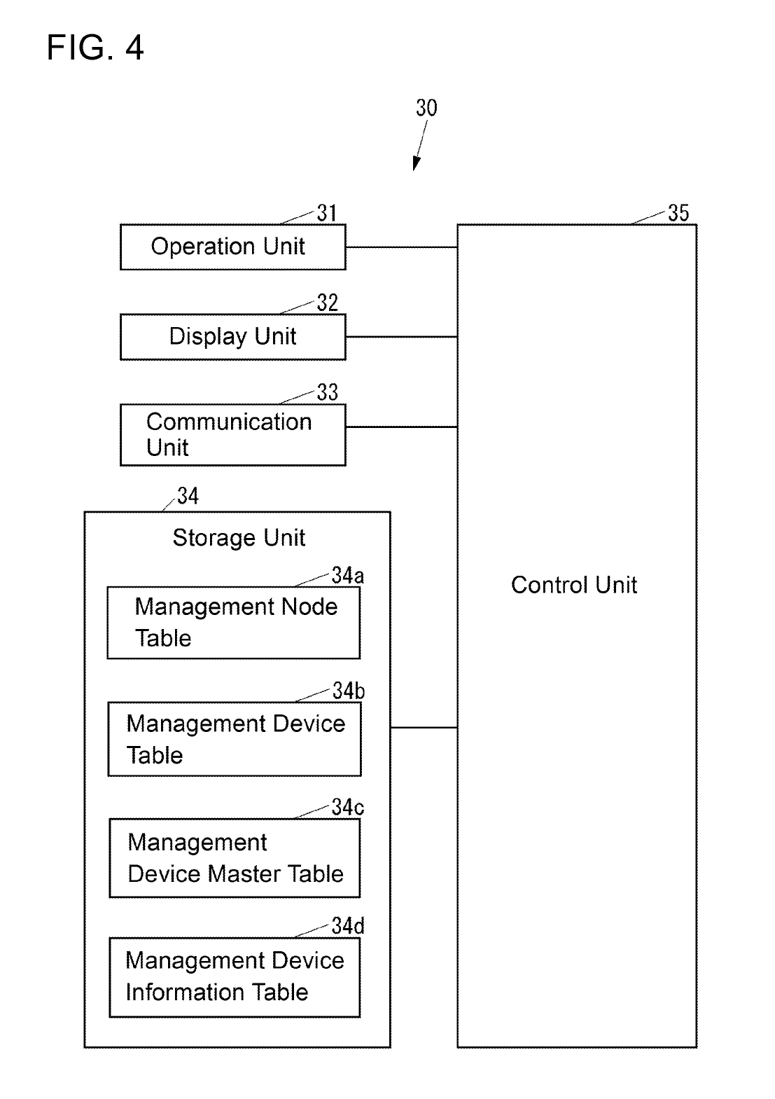

FIG. 4 illustrates the database server 30.

As illustrated in FIG. 4, the database server 30 includes an operation unit 31, a display unit 32, a communication unit 33, a storage unit 34, and a control unit 35. The operation unit 31 is an input circuit such as a computer mouse and a keyboard for receiving various kinds of operations. The display unit 32 is a display circuit such as a LCD that displays various kinds of information. The communication unit 33 is a network communication circuit that communicates with an external device via the network 11 (see FIG. 1). The storage unit 34 is a storage circuit such as a HDD that stores programs and various kinds of data. The control unit 35 is a circuit that controls the entire database server 30. The database server 30 is constituted of, for example, a computer such as a PC.

The storage unit 34 may store a management node table 34a, a management device table 34b, a management device master table 34c, and a management device information table 34d. The management node table 34a includes the person who is managed by the support server 20, namely a node (hereinafter referred to as a “management node”). The management device table 34b includes the product managed by the management node, namely a device (hereinafter referred to as a “management device”). The management device master table 34c includes a kind of attribute for the management device as attribute kind information. The management device information table 34d includes an attribute value indicative of actual content against the kind of attribute for the management device as attribute value information. The management node table 34a, the management device table 34b, the management device master table 34c, and the management device information table 34d constitute at least a part of the customer information.

The control unit 35 includes, for example, a CPU, a ROM, which stores programs and various kinds of data, and a RAM, which is used as a work area of the CPU. CPU may execute the program that is stored in the ROM or the storage unit 34.

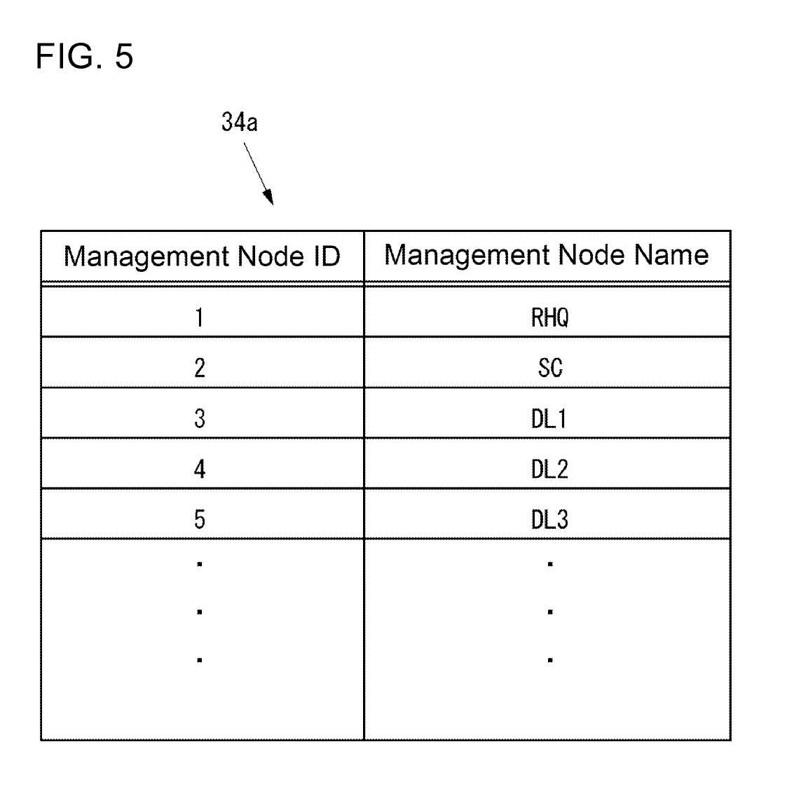

FIG. 5 illustrates an exemplary management node table 34a.

The management node table 34a illustrated in FIG. 5 stores a relationship between an ID of the management node (hereinafter referred to as a “management node ID”) and a management node name indicative of a name of the management node.

The example illustrated in FIG. 5 designates that the management node name of the management node with the management node ID of “1” is “RHQ” indicative of the RHQ among the administrators 72. The management node name of the management node with the management node ID of “2” is “SC” indicative of the SC among the administrators 72. The management node name of the management node with the management node ID of “3” is “DL1” indicative of the dealer 74. The management node name of the management node with the management node ID of “4” is “DL2” indicative of the dealer 75. The management node name of the management node with the management node ID of “5” is “DL3” indicative of the dealer 76.

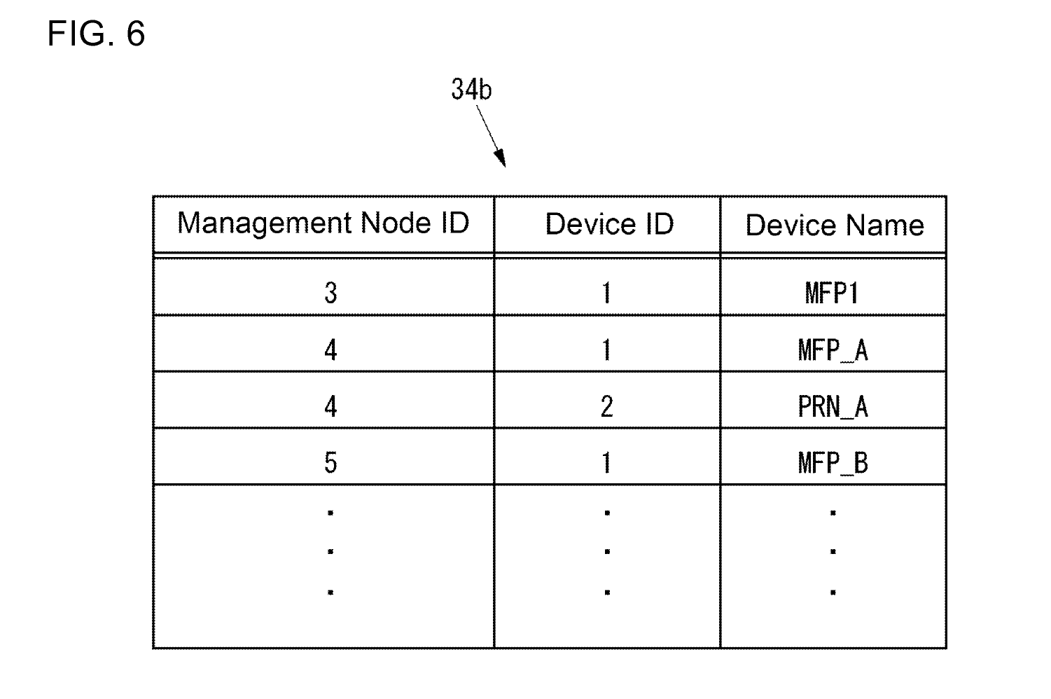

FIG. 6 illustrates an exemplary management device table 34b.

The management device table 34b illustrated in FIG. 6 stores the relationship among the management node ID, an ID of the management device (hereinafter referred to as a “device ID”), and a device name indicative of a name of the management device.

The management node ID in the management device table 34b is identical to the management node ID defined in the management node table 34a (see FIG. 5). The device ID is independently defined in units of the management node ID.

The example illustrated in FIG. 6 designates that the management node with the management node ID of “3” manages the device of which the device ID and the device name are respectively “1” and “MFP1.” The management node with the management node ID of “4” manages both devices, of which the device ID and the device name are respectively “1” and “MFP_A,” and of which the device ID and the device name are respectively “2” and “PRN_A.” The management node with the management node ID of “5” manages the device of which the device ID and the device name are respectively “1” and “MFP_B.” The devices of; the management node ID of “3” and the device ID of “1,” the management node ID of “4” and the device ID of “1,” and the management node ID of “5” and the device ID of “1” are such as the MFPs. The device of; the management node ID of “4” and the device ID of “2” is such as a printer-only machine.

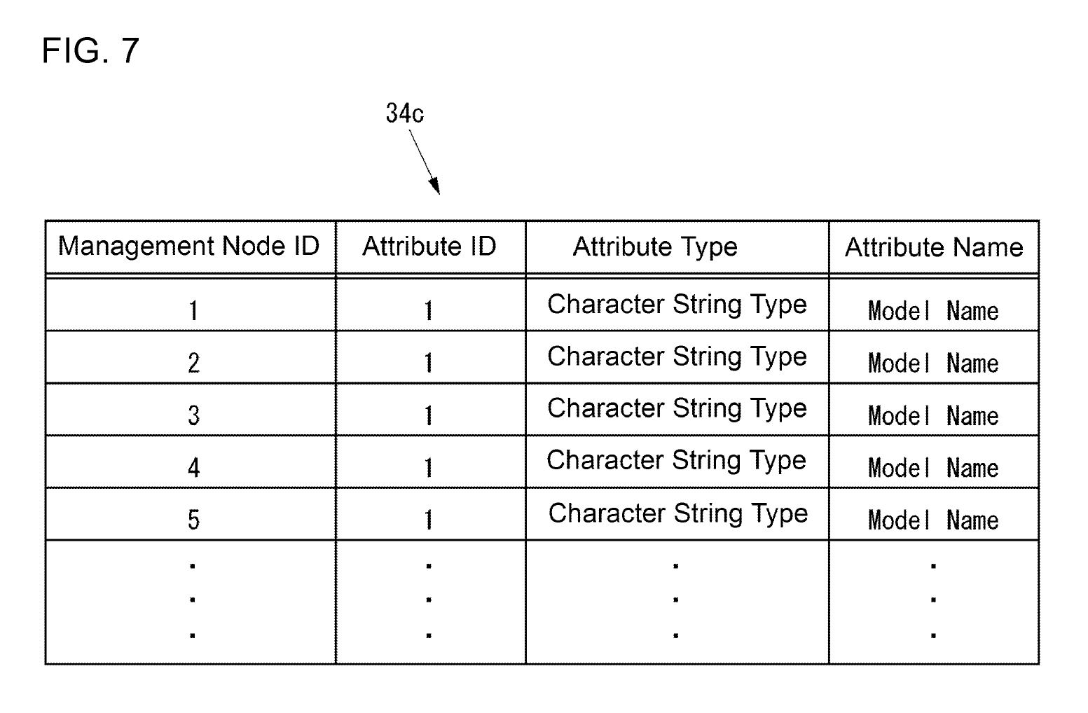

FIG. 7 illustrates an exemplary management device master table 34c.

The management device master table 34c illustrated in FIG. 7 stores the relationship among the management node ID, an ID of attribute for the management device (hereinafter referred to as a “attribute ID”), an attribute type indicative of a type of attribute for the management device, and an attribute name indicative of a name of attribute for the management device. That is, the management device master table 34c stores a “kind of attribute” by each dealer.

The management node ID in the management device master table 34c is identical to the management node ID defined in the management node table 34a (see FIG. 5). The attribute ID is independently defined in units of the management node ID.

The example illustrated in FIG. 7 designates that the values of “1” as the attribute ID with the attribute of “character string type” for the attribute type and “Model Name” for the attribute name are set to be specified in the respective management nodes of the management node IDs of “1,” “2,” “3,” “4,” and “5.”

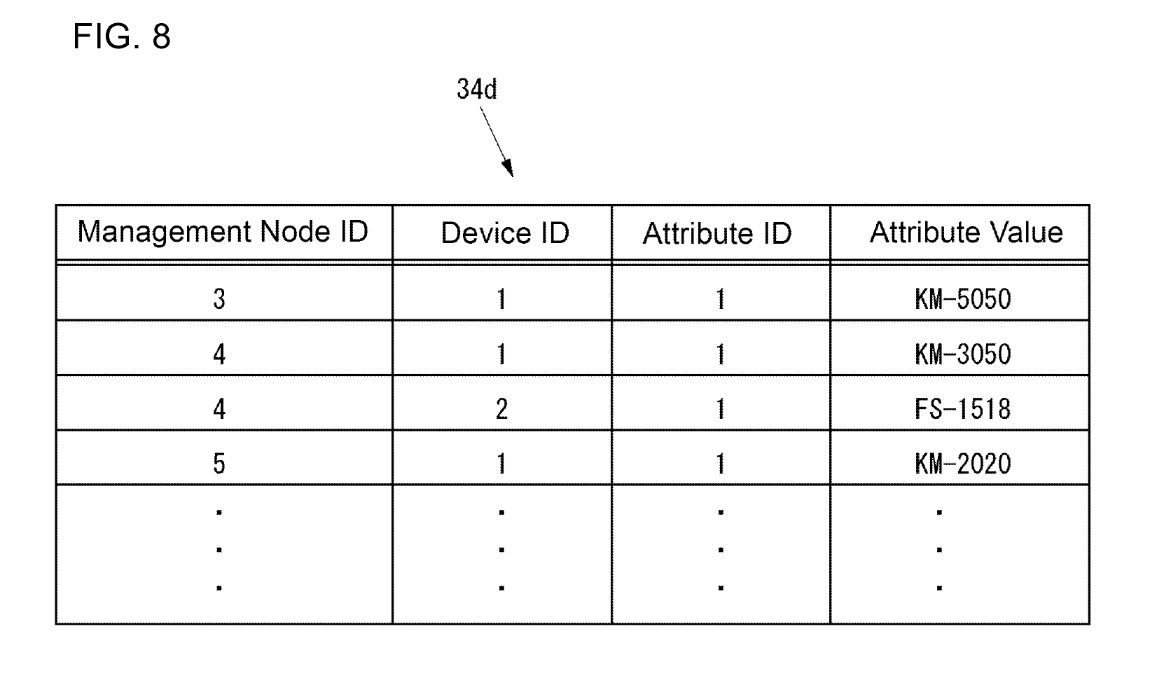

FIG. 8 illustrates an exemplary management device information table 34d.

The management device information table 34d illustrated in FIG. 8 stores a relationship among the management node ID, the device ID, the attribute ID, and the attribute value. That is, the management device information table 34d stores the attribute value by a “dealer,” a “product,” and a “kind of attribute.”

The management node ID of the management device information table 34d is identical to the management node ID defined in the management node table 34a (see FIG. 5). The device ID of the management device information table 34d is identical to the device ID defined in the management device table 34b (see FIG. 6). The attribute ID of the management device information table 34d is identical to the attribute ID defined in the management device master table 34c (see FIG. 7).

The example illustrated in FIG. 8 designates that the attribute value of the attribute with the attribute ID of “1” specified in the device with the device ID of “1” managed by the management node with the management node ID of “3” is “KM-5050.” The attribute value of the attribute with the attribute ID of “1” specified in the device with the device ID of “1” managed by the management node with the management node ID of “4” is “KM-3050.” The attribute value of the attribute with the attribute ID of “1” specified in the device with the device ID of “2” managed by the management node with the management node ID of “4” is “FS-1518.” The attribute value of the attribute with the attribute ID of “1” specified in the device with the device ID of “1” managed by the management node with the management node ID of “5” is “KM-2020.”

The following describes the operations executed by the support server 20.

First, the operation executed by the support server 20 at the dealer's request for a use of functions will be described.

The dealer is required to login to the support server 20 before requesting the support server 20 for the use of functions. The dealer gives an instruction of login to the support server 20 to the user terminal. Accordingly, the user terminal requests for the dealer's login to the support server 20 by sending the login ID and password inputted by the dealer to the support server 20 via the network 11. Upon login request from the user terminal, the control unit 25 of the support server 20 permits the dealer to login where an ID and password combination sent from the user terminal is included in the dealer information 24b. The control unit 25 does not permit the dealer to login where an ID and password combination sent from the user terminal is not included in the dealer information 24b.

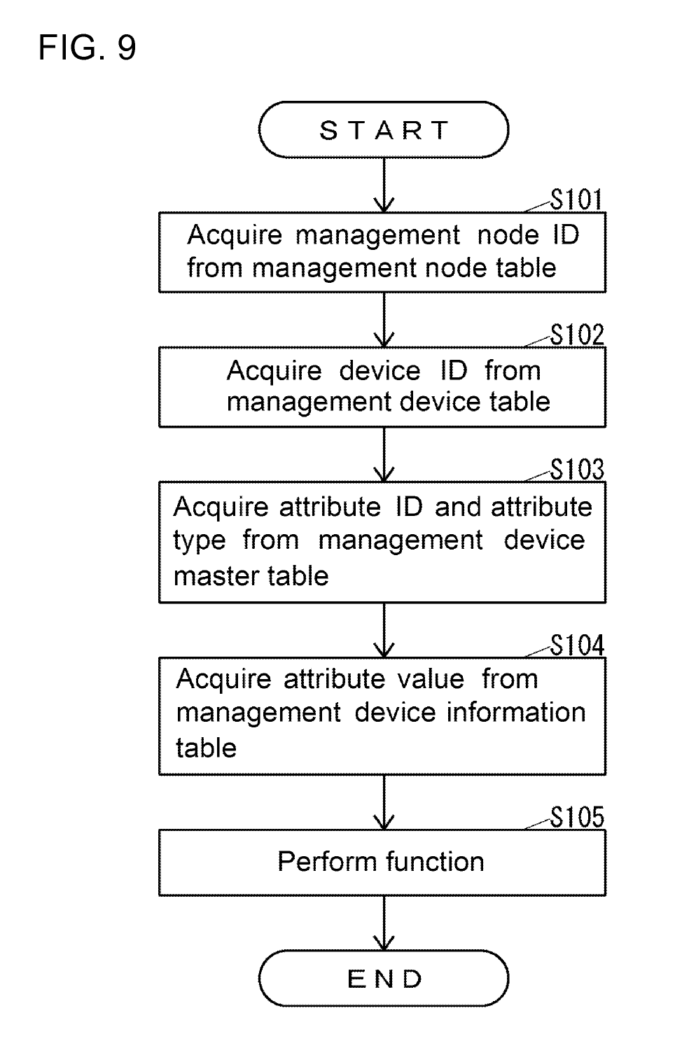

The dealer permitted to login by the support server 20 gives an instruction of use of the functions provided by the support server 20 to the user terminal. Accordingly, the user terminal requests for the use of functions to the support server 20 via the network 11. Upon request for the use of functions from the user terminal, the control unit 25 of the support server 20 executes the operations illustrated in FIG. 9.

FIG. 9 illustrates a flow chart of the operations executed by the support server 20 when the use of functions is requested.

As illustrated in FIG. 9, the customer information management unit 25b acquires the management node ID of a logged in dealer from the management node table 34a in the database server 30 based on the management node name of the logged in dealer (Step S101).

Subsequently, the customer information management unit 25b acquires the device ID of the target product for the function being requested for use by the dealer from the management device table 34b in the database server 30 based on the management node ID acquired in Step S101 and the device name of the target product for the function being requested for use by the dealer (Step S102).

Subsequently, the customer information management unit 25b acquires the attribute ID and the attribute type of the attribute for the target product for the function being requested for use by the dealer from the management device master table 34c in the database server 30 based on the management node ID acquired in Step S101 and the attribute name of the attribute for the target product for the function being requested for use by the dealer (Step S103).

Subsequently, the customer information management unit 25b acquires the attribute value of the attribute for the target product for the function being requested for use by the dealer from the management device information table 34d in the database server 30 based on the management node ID acquired in Step S101, the device ID acquired in Step S102, and the attribute ID acquired in Step S103 (Step S104).

Subsequently, the function execution unit 25a uses the attribute value acquired in Step S104 to execute the function (Step S105). Here, the function execution unit 25a handles the attribute value as the value of the attribute type acquired in Step S103 when using the attribute value in order to execute the function.

Upon completion of the process of Step S105, the function execution unit 25a terminates the operations illustrated in FIG. 9.

Secondly, the operation executed by the support server 20 for the kind of attribute being customized will be described.

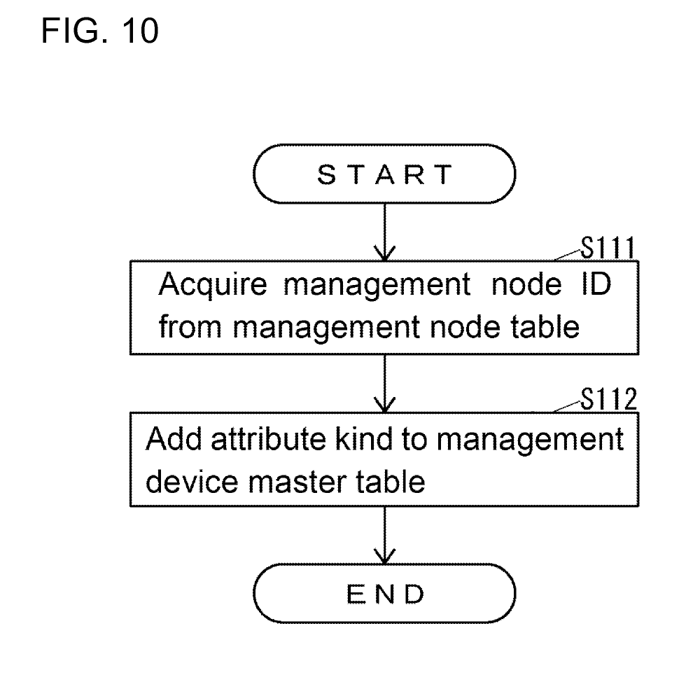

The administrator 72 or the dealer himself or herself gives an instruction of addition of the kind of attribute for the management device of the specific dealer via such as the operation unit 21. Accordingly, the control unit 25 of the support server 20 executes the operations illustrated in FIG. 10.

FIG. 10 illustrates a flow chart of the operations executed by the support server 20 when the kind of attribute is customized.

As illustrated in FIG. 10, the customer information management unit 25b acquires the management node ID of the dealer from the management node table 34a in the database server 30 based on the management node name of the dealer that is given the instruction of addition of the kind of attribute for the management device (Step S111).

Subsequently, the customer information management unit 25b adds the attribute type and the attribute name of the attribute being given the instruction of addition to the management device master table 34c in the database server 30 based on the management node ID acquired in Step S111 (Step S112). Here, the customer information management unit 25b, in Step S112, specifies the attribute ID, which is yet to be specified prior to the process of Step S112 in the management device master table 34c, in the management node ID acquired in Step S111.

Upon completion of the process of Step S112, the customer information management unit 25b terminates the operations illustrated in FIG. 10.

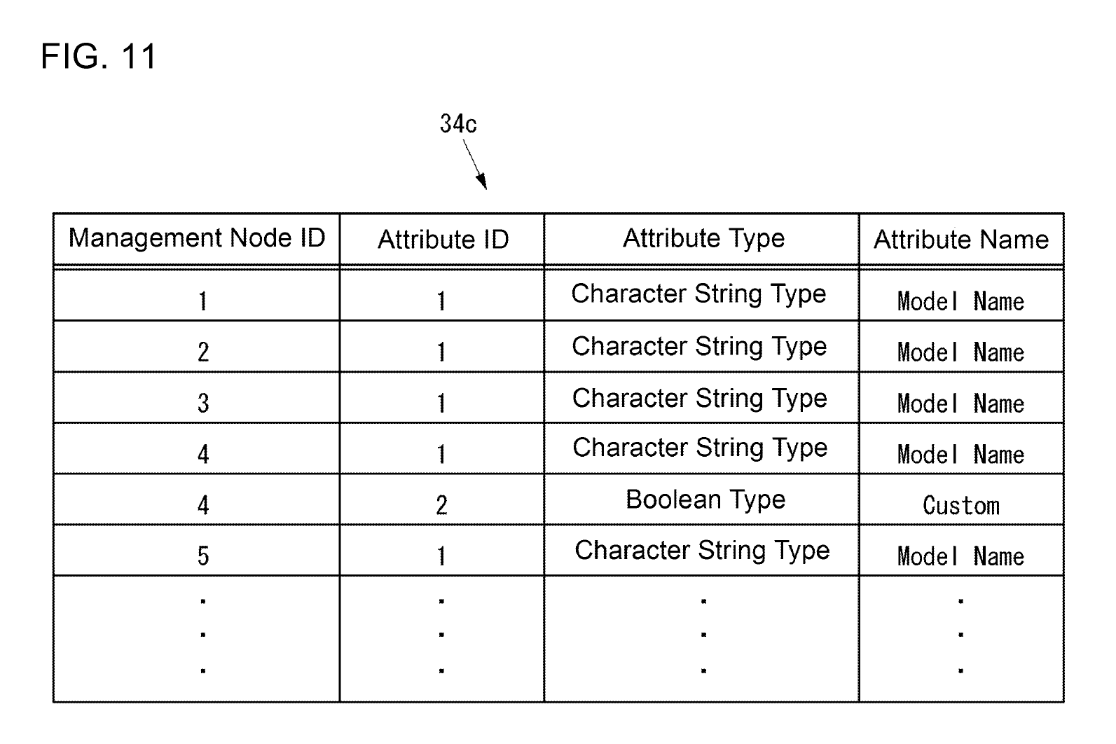

FIG. 11 illustrates an exemplary management device master table 34c customized by the operations illustrated in FIG. 10.

In comparison with the management device master table 34c illustrated in FIG. 7, the management device master table 34c illustrated in FIG. 11 adds the kind of attribute where the attribute ID, the attribute type, and the attribute name are respectively “2,” “Boolean type”, and “Custom” to the management node with the management node ID of “4.” The kind of attribute newly added is such as the attribute indicative of whether or not the product maintenance is completed.

Next, the operation executed by the support server 20 for the attribute value being input will be described.

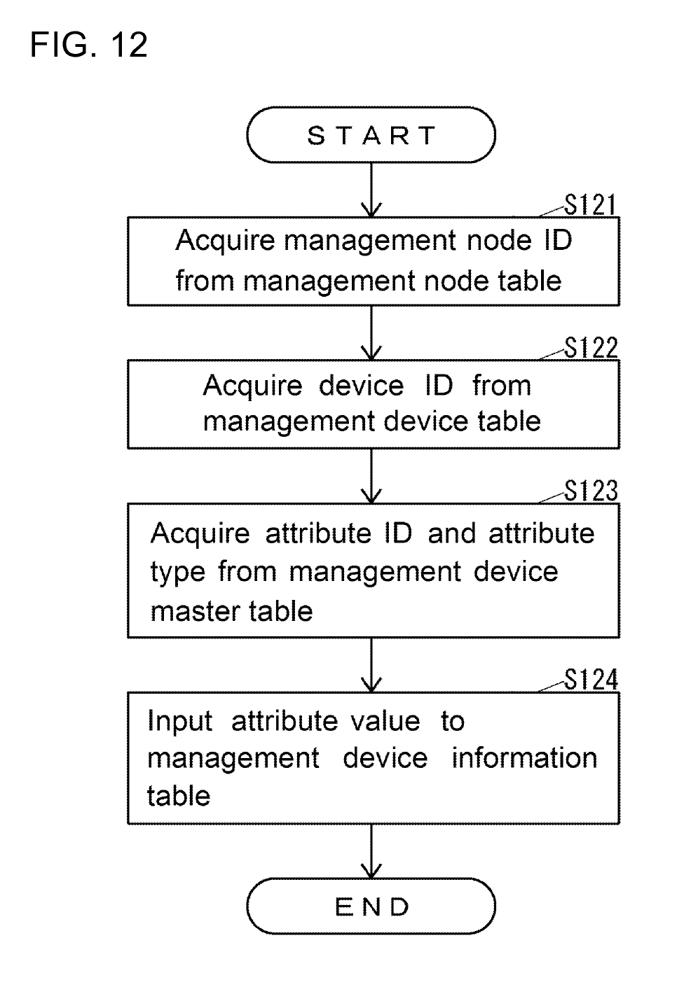

The dealer is required to login to the support server 20, as described above, before requesting the support server 20 to input the attribute value. The dealer permitted to login by the support server 20 gives an instruction of input of the attribute value to the user terminal. Accordingly, the user terminal requests for the input of the attribute value to the support server 20 via the network 11. Upon request for the input of the attribute value from the user terminal, the control unit 25 of the support server 20 executes the operations illustrated in FIG. 12.

FIG. 12 illustrates a flow chart of the operations executed by the support server 20 when the input of the attribute value is requested.

As illustrated in FIG. 12, the customer information management unit 25b acquires the management node ID of a logged in dealer from the management node table 34a in the database server 30 based on the management node name of the logged in dealer (Step S121).

Subsequently, the customer information management unit 25b acquires the device ID of the target product requested for the input of the attribute value by the dealer from the management device table 34b in the database server 30 based on the management node ID acquired in Step S121 and the device name of the target product requested for the input of the attribute value by the dealer (Step S122).

Subsequently, the customer information management unit 25b acquires the device ID and the attribute type of the attribute requested for the input of the attribute value by the dealer from the management device master table 34c in the database server 30 based on the management node ID acquired in Step S121 and the attribute name of the attribute requested for the input of the attribute value by the dealer (Step S123).

Next, the customer information management unit 25b inputs the attribute values requested for the input by the dealer associated with the management node ID acquired in Step S121, the device ID acquired in Step S122, and the attribute ID acquired in Step S123 to the management device information table 34d in the database server 30 (Step S124). Here, the customer information management unit 25b inputs the attribute value to the management device information table 34d, if and only if the attribute value to be inputted matches the attribute type acquired in Step S123.

Upon completion of the process of Step S124, the customer information management unit 25b terminates the operations illustrated in FIG. 12.

The support server 20 may use a new attribute value inputted by the operations illustrated in FIG. 12 to execute the function as illustrated in FIG. 9.

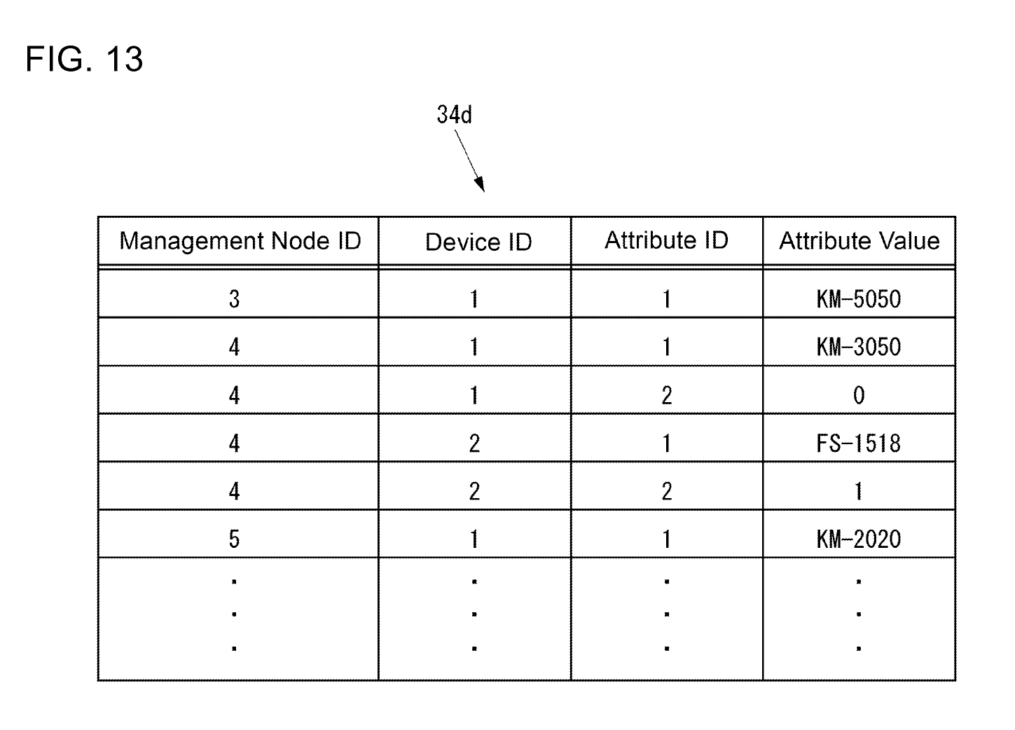

FIG. 13 illustrates an exemplary management device information table 34d has the attribute values inputted by the operations illustrated in FIG. 12

In comparison with the management device information table 34d illustrated in FIG. 8, the management device information table 34d illustrated in FIG. 13 further includes “0,” and “1” as the attribute values of the attributes with the attribute ID of “2” specified in the respective devices with the device IDs of “1,” and “2” managed by the management node with the management node ID of “4.” The attribute value with the attribute with the management node ID of “4” and the attribute ID of “2” indicates, for example, the completion of the product maintenance in case of the value of “0,” and no completion of the product maintenance in case of the value of “1.”

Above all, the method, which the dealer himself or herself requests for the new attribute value for the product managed by the dealer to be added to the management device information table 34d to the support server 20 via the user terminal, is described. However, the administrator 72 may also request for the new attribute value for the product managed by the management node to be added to the management device information table 34d to the support server 20 via such as the operation unit 21 of the support server 20. The customer information management unit 25b of the support server 20 may automatically add the attribute value to the management device information table 34d depending on the kind of attribute. For example, as for the attribute with the attribute name of “Model Name,” the customer information management unit 25b may also remotely search the product, automatically acquire the attribute value of the product, namely the model name from the product, and then add the acquired model name to the management device information table 34d.

The administrator 72 may request for the new the management node to be added to the management node table 34a, and for the new product managed by the management node to be added to the management device table 34b to the support server 20 via such as the operation unit 21 of the support server 20.

The dealer may request for the new product managed by the dealer himself or herself to be added to the management device table 34b to the support server 20 via the user terminal used by the dealer himself or herself.

As stated previously, the support server 20 and the support program 24a may handle all dealers with a single system. This ensures the elimination of the necessity of arranging one system for each dealer and the reduction of the management load of the administrators 72. The support server 20 and the support program 24a may handle all dealers with a single system. This ensures the elimination of the necessity of developing one system for each dealer and the reduction of the development load.

The support server 20 executes the function based on the management device master table 34c that stores the kind of attribute for the product by each dealer. This ensures that the kind of attribute is tailored for each dealer to be customized. Furthermore, even if the kind of attribute is customized per dealer, the relationship among the management node table 34a, the management device table 34b, the management device master table 34c, and the management device information table 34d remain unchanged. This causes no schema change for the database. Accordingly, even if the kind of attribute is customized per dealer, the support program 24a is no longer required to be customized per dealer. This ensures that the support server 20 reduces the development load of the support program 24a and the management load of the administrator handling the support program 24a.

Assume that the support program 24a is required to be customized per dealer when the kind of attribute is customized per dealer. In this case, the customization of the kind of attribute for any one of dealers causes the other dealers in addition to the any one of dealers to unable to use the support program 24a while the support program 24a is being modified. However, even if the kind of attribute is customized per dealer, the support program 24a is no longer required to be customized per dealer. Accordingly, the support server 20 does not specially impact the availability for the other dealers and may continue to be used by the other dealers even if the kind of attribute is customized for any one of dealers.

As stated previously, according to the disclosure, the kind of attribute in a multi-tenant application for fleet management may be customized per dealer.

The database server 30 is a different hardware from the support server 20 in this embodiment. However, the support server 20 may also function as the database server 30.

The system 10, as previously stated, includes a single database server as the database server storing the customer information, namely, the database server 30 alone. However, the system 10 may also include plurality of database servers as the database server storing the customer information. The multiple database servers may also be built in a cloud service.

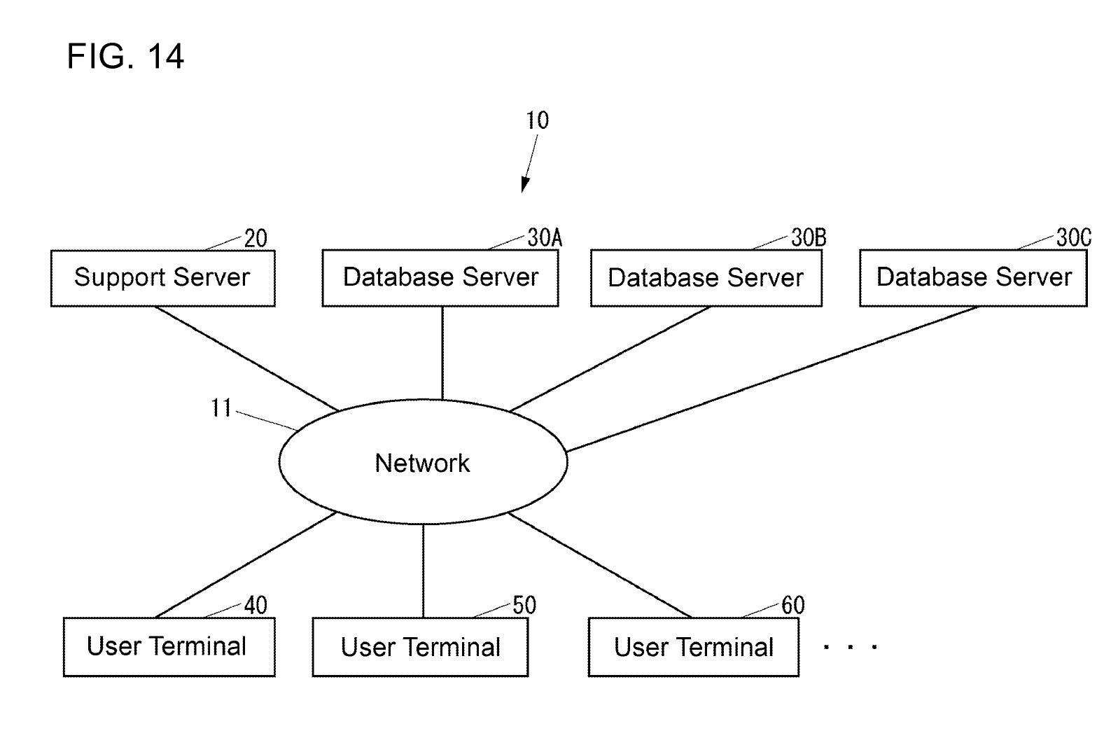

FIG. 14 illustrates the system 10, which includes the multiple database servers.

The configuration of the system 10 illustrated in FIG. 14 is similar to those in which the system 10 illustrated in FIG. 1 includes database servers 30A, 30B, and 30C instead of the database server 30.

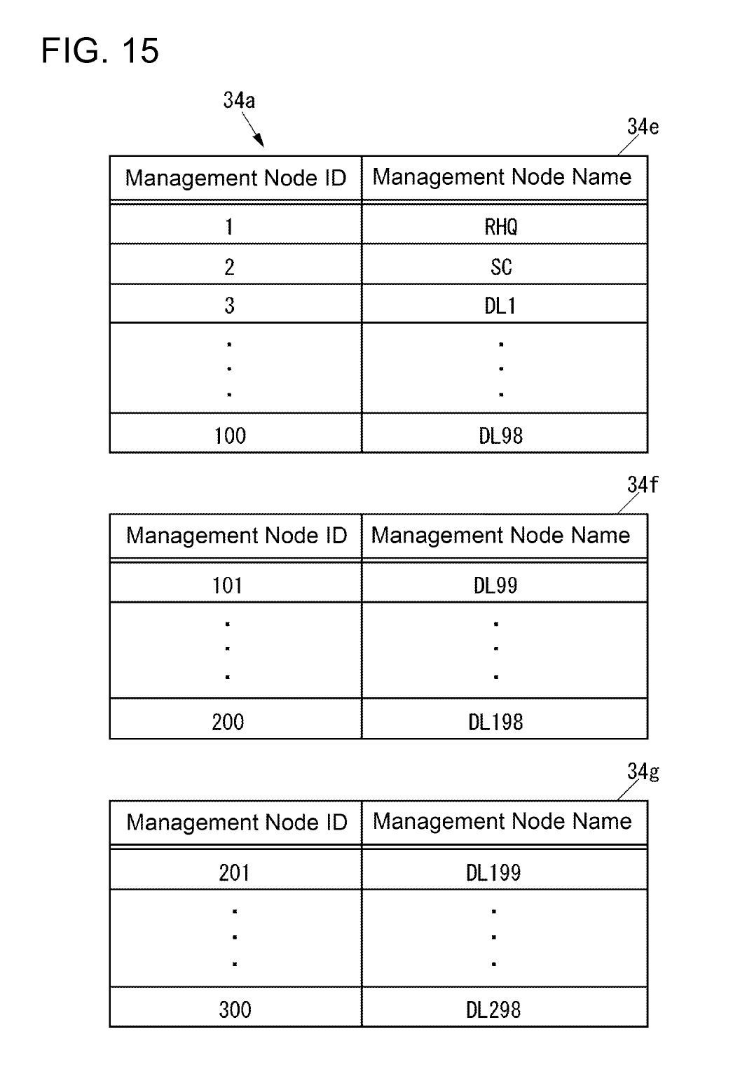

FIG. 15 illustrates an exemplary management node table 34a stored in the database servers 30A, 30B, and 30C.

As illustrated in FIG. 15, the management node table 34a is divided into three tables of: a table 34e with the value of the management node ID ranging from “1” to “100,” a table 34f with the value of the management node ID ranging from “101” to “200,” and a table 34g with the value of the management node ID ranging from “201” to “300.”

The tables 34e, 34f, and 34g are stored in the database servers 30A, 30B, and 30C, respectively.

That is, the customer information management unit 25b of the support server 20 separately stores the respective tables, where the management node table 34a as a part of the customer information is divided into more than one, in the different database servers.

For the configurations illustrated in FIGS. 14 and 15, the management node table 34a is divided based on every one hundred records of the management node to be separately stored in the different database servers. However, a count of records of the management node on a per division of the management node table 34a basis depends on the settings. For the configurations illustrated in FIGS. 14 and 15, the management node table 34a includes three hundreds records of the management node. However, the maximum count of records of the management node included in the management node table 34a depends on the settings. The count of database servers may increase where appropriate.

FIG. 15 illustrates the only state where the management node table 34a is divided. However, the customer information management unit 25b may also separately stores the respective tables, of which the management device table 34b, the management device master table 34c, and the management device information table 34d being a part of the customer information is each divided into more than one, in the different database servers.

The support server 20 may execute load balancing of processing the customer information across the respective tables in the multiple database servers when to separately store the respective tables of being divided the customer information into more than one in the different database servers. This ensures that the support server 20 executes the function at an adequate speed even if the large amount of the total information volume of the customer information is provided. For example, the support server 20 can execute the function at an adequate speed even if: the count of at least one of the dealer to be managed, the product, and the attribute increases, which causes the amount of information of data of at least one of the management node table 34a, the management device table 34b, the management device master table 34c, and the management device information table 34d to increase; or the dealer to be managed increase, which causes the count of concurrent access users to increase.

The administrator 72, as previously stated, inputs the instructions to the support server 20 via the operation unit 21 of the support server 20. However, the administrator 72 may also inputs the instructions to the support server 20 via the operation unit of a computer being communicatively connected to the support server 20 via the network 11.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A support system comprising:
a function execution circuit that uses customer information indicative of a specific content related to a customer to execute a specific function; and
a customer information management circuit that manages the customer information; wherein
the customer information management circuit manages a piece of attribute kind information storing a kind of attribute for a product for each dealer, and attribute value information storing an attribute value indicative of an actual content for the kind for each of combinations of the dealers, the products, and the kinds, as a part of the customer information, and
the function execution circuit uses the attribute acquired based on the attribute kind information and the attribute value information to execute the function.

2. The support system according to claim 1, wherein the customer information management circuit stores respective pieces of customer information into different database servers, the customer information being divided in the respective pieces of customer information.

3. A support system method comprising:
using, via a function execution circuit, customer information indicative of a specific content related to a customer to execute a specific function; and
managing, via a customer information management circuit, the customer information; wherein
the managing includes managing a piece of attribute kind information storing a kind of attribute for a product for each dealer, and attribute value information storing an attribute value indicative of an actual content for the kind for each of combinations of the dealers, the products, and the kinds, as a part of the customer information, and
the using includes using the attribute acquired based on the attribute kind information and the attribute value information to execute the function.

4. A non-transitory computer-readable recording medium storing a support program to control a support system, the support program causing the support system to function as:
a function execution circuit that uses customer information indicative of a specific content related to a customer to execute a specific function; and
a customer information management circuit that manages the customer information; wherein
the customer information management circuit manages a piece of attribute kind information storing a kind of attribute for a product for each dealer, and attribute value information storing an attribute value indicative of an actual content for the kind for each of combinations of the dealers, the products, and the kinds, as a part of the customer information, and
the function execution circuit uses the attribute acquired based on the attribute kind information and the attribute value information to execute the function.
